(19) United States
(12) Patent Application Publication
(10) Pub. No.: US 2011/0281245 A1
(43) Pub. Date: Nov. 17, 2011

(54) System for Regulating Caloric Intake and Method for Using Same

(76) Inventor: Joumana Mansour, Naperville, IL (US)

(21) Appl. No.: 12/781,462

(22) Filed: May 17, 2010

(51) Int. Cl. G09B 19/00

(52) U.S. Cl. 434/127

(57) ABSTRACT

A system for regulating caloric intake is disclosed, along with a method for using the system. The system includes a plurality of labeled dishes. Each dish is sized to receive approximately a predetermined, desired volume of food selected from a food group. Each dish is further provided with a label portion positioned on the outer portion of the dish having written information about the caloric content per predetermined, desired volume of a plurality of foods selected from the food group.

### FIELD OF THE INVENTION

A system for regulating caloric intake is disclosed, along with a method for using the system. The system and method can be adapted to assist a user to maintain a diet, most often to enable weight loss. The system includes a plurality of specially labeled bowls to be used with respective food groups (e.g. meats, vegetables, fruits and grains), each sized to assist portion control and labeled to provide caloric content information for a selection of popular foods within a particular food group. The system can optionally include a glass sized to assist portion control, further having a movable counter mechanism constructed and arranged to assist in monitoring water consumption. A booklet can optionally be provided to assist in determining the proper caloric intake for the user's goals, in total and for each food group. The booklet can contain information regarding the desired total daily caloric intake based on the user's gender, age, activity level and goals (weight loss, weight gain, weight maintenance) and further can include data for selecting the proper daily caloric intake of foods within the various food groups, thereby assisting the user to maintain a balanced diet. A tablet or diary and pen can be optionally provided so the user can record information, as set forth in the system.

### BACKGROUND OF THE INVENTION

For years, the percentage of U.S. residents that are overweight or obese has been increasing. Recently, it has been observed that the problem is worldwide, and not simply a U.S. problem. However, individual efforts to lose or control weight are often unsuccessful. While the reasons for this are numerous, many people fail in their efforts simply because they are misinformed. Other times, people fail in their efforts because it is too difficult to stick to a diet. This can occur because it is inconvenient to maintain good habits, or because willpower is lacking when a concentrated effort is required.

Less commonly observed, but still widespread, is the need for more particularized nutritional habits among those who wish to gain weight, monitor intake of certain foods (e.g. diabetics) or simply ensure a better distribution of healthy food intake.

Thus, there is need for a system for regulating caloric intake and a method of using the same that provides a more uniform, healthy distribution of caloric intake from a variety of food groups, to facilitate better nutritional habits.

The following U.S. patents and published applications illustrate the efforts of others to address the problems identified and solved by the disclosure herein.

U.S. Pat. No. 7,416,094, issued on Aug. 26, 2008 to Sokola, Sr., entitled “Dinnerware with Attached Figure and Diet Reminder,” generally discloses a dinnerware article, such as a dish or plate, bearing a raised likeness of a creature connoting obesity. The article also bears a graphical diet reminder, instructing the user regarding healthful amounts and/or types of foods for his/her consumption.

U.S. Pat. No. 7,044,739, issued on May 16, 2006 to Matson, entitled “System for Controlled Nutrition Consumption,” generally discloses a system for and a method of modifying eating habits of a user. The system and method utilize a set of fixed volume containers that are graduated to provide a user means to control the volume of food consumed over time. The contents of the containers are consumed over time according to a schedule which identifies the appropriate containers and the frequency of the meals to be consumed each day. Preferably, the method is used for weight reduction, wherein the volume of food consumed per meal is reduced over time while frequency of meals consumed over time is simultaneously increased over time, in order to balance the nutritional intake of the user. The fixed volume containers can be pre-filled or provide the user with a measuring means to portion his/her own food. The system and method can be customized to suit the dietary goals of an individual and can be used along with a printed and/or electronic schedule and/or a workbook to further motivate the user to modify his/her eating habits to achieve a set of user goals. More specifically, U.S. Pat. No. 7,044,739 discloses controlled nutrition consumption, which comprises controlling the volume of meals by measuring meals with containers having predetermined fixed volumes based on the customized schedule (FIGS. 1, 3a, Elements 103, 107, 300, 330; Claim 1; Column 3, Lines 4 to Column 4, Lines 37). At FIG. 4A, a flowchart shows a simple logic for reducing food intake by trial and error.

U.S. Pat. No. 6,513,532, issued on Feb. 4, 2003 to Mault et al., entitled “Diet and Activity-Monitoring Device,” generally discloses a diet and activity-monitoring device including a timer which outputs a time-indicative signal. A body activity monitor monitors the body activity of a subject and outputs a signal indicative of the body activity. A consumption notation control is provided which the subject may operate to indicate when they consume food. An activity calculator receives the body activity signal and determines a body activity level for the subject. A consumption calculator communicates with the consumption notation control and receives the time-indicative signal. The consumption calculator determines and stores the times when the consumption location control is operated. More specifically, U.S. Pat. No. 6,513,532 discloses a monitoring device for diet and activity, which comprises means to indicate when the dieter has eaten food and the food eaten and measure caloric intake (FIGS. 2, 6, 9, Elements 36, 140, 164; Claims 1, 7, 17, 22, 26; Column 6, Lines 31 to Column 8, Lines 42).

U.S. Pat. No. 6,296,488, issued on Oct. 2, 2001 to Brenkus et al., entitled “Diet Methods and Apparatus,” generally discloses a diet method which is designed to provide the user with a balanced diet while restricting the caloric intake by controlling the portion size in a simple and convenient manner. The method employs an apparatus which is preferably in the shape of a plate comprising a plurality of compartments which are designed to enclose a specified volume of food. The apparatus is used with associated meal cards having a variety of foods listed thereon. The foods are listed in specific sections on the card which correspond to the compartments of the apparatus. The meal cards are positioned such that the food list for a particular compartment fits in the shape of the compartment such that the user can see the selectable food items which may be used to fill the corresponding compartment. The user is provided with a simple method in which they do not have to weigh or measure the food amount, no calculating or recording is required, and decks of individual food items do not need to be bothered with. More specifically, U.S. Pat. No. 6,296,488 discloses a diet for controlling food portion volumes, which comprises a plate including a number of compartments which are designed to enclose a specified volume of food. A booklet and a glass are included (FIG. 10).

U.S. Pat. No. 5,560,653, issued on Oct. 1, 1996 to Beppu, entitled “Dietary Dish,” generally discloses a dietary dish used for a person who must diet due to disease, such as diabetes. This dietary dish comprises at least one actual size photograph or detailed illustration of the foods to be served, printed on the bottom surface. More specifically, U.S. Pat. No. 5,560,653 discloses dietary dish with partitions dividing the dish into areas with transparent bottoms, and photographs of food and caloric information printed on plastic matter on which dish is set (FIGS. 1 and 3; Claims 1 and 13; Column 2, Lines 65; Column 3, Lines 2).

U.S. Pat. No. 5,454,721, issued on Oct. 3, 1995 to Kuch, entitled “Application of Multi-Media Technology to Nutrition Education and Diet Planning,” generally discloses a system to teach individuals the relationship between the visual size and the nutritional characteristics of portions of food by using either a life-sized image of, or the corporeal finger of the individual as a scale against life-sized images of different sized portions of different kinds of food. The system shows the nutritional characteristics of such portions and provides instruction on how to adjust the relative sizes of portions of food to provide a nutritionally well-balanced meal (FIG. 4, Elements 110, 208, 206, 204, 202; Claim 1; Column 10, Line 57).

U.S. Pat. No. 5,007,743, issued on Apr. 16, 1991 to Brennan, entitled “Food Metering Dish,” generally discloses an apparatus for use as a dieting aid by individuals, wherein a dish member includes a continuous surrounding wall defining an interior cavity. The interior cavity includes first and second concave recesses for receiving metered containers therewithin each having metering designations consistent with dieting portions available to an individual. The containers each include sealing lids selectively securable thereon for maintaining freshness and temperature within the containers. The continuous wall includes a cavity filled with a mineral oil to retain heat within the cavity and impart such heat to food contained within the interior cavity of the dish. A thermometer is integrally and optionally formed to an exterior surface of the wall, and additionally the dish may include a medial partition wall with spaced pairs of ribs containing selectively partitionable partition walls between the ribs for selective control of food portions contained between the partition walls. FIGS. 4, 8, Elements 15, 14, 12a, 21, 23, 25; Claim 1; Column 3, Lines 38 to Column 4, Lines 50. Limited data regarding the caloric content of some foods is disclosed.

U.S. Pat. No. 4,976,622, issued on Dec. 11, 1990 to Clark, entitled “Diabetic Diet Plan Aid and Method,” generally discloses a system to aid a person in learning a prescribed diet, including food groups, allowed food portions, prescribed meal and medication schedule in which a two panel folder is provided, each panel having a set of pockets labeled for each meal and snack of a day of the diet. A clock face is pictured on each pocket, showing the average meal time, such as for a patient with diabetes and a space on each pocket for the patient to pencil in his own time for meals, if it differs from the pictured time. Several tickets or cards are also provided labeled with food group choices and medication, optionally with a picture symbol representative of the particular food group or medication. On the back of each card is a list of several foods and allowed portions of the prescribed diet, each card list being different to help the patient plan meals with different allowed foods. The patient first matches cards listing the items and portions of food allowed for each meal or snack, then places the food cards into the pockets of one panel of the folder representative of the meals and snacks of one day of the diet. If medication is prescribed, matching tickets are placed in the meal pockets that meet the medication schedule. Starting with breakfast, as the patient takes medication or uses each food portion allowed at the prescribed time, he takes the matching card from its respective pocket, and places it into the corresponding pocket on the other panel of the folder. This procedure is repeated for each meal or snack item consumed during the given day whereby at the end of the day all cards of items consumed will be transferred to the pockets of the other panel of the folder, ready for the next day's use. No need exists to reset the cards unless the prescribed diet is changed. More specifically, U.S. Pat. No. 4,976,622 discloses a system to aid a person in learning a prescribed diet, which comprises food groups, allowed food portions, prescribed meal and medication schedule in which a two panel folder is provided, each panel having a set of pockets labeled for each meal and snack of a day of the diet (FIGS. 1-3, Elements 20a-20c; Claims 1, 3, 11, 14; Columns 12-14).

U.S. Pat. No. 4,966,295, issued on Oct. 30, 1990 to Parrish, entitled “Dieting Plate Arrangement with Movable Partitions,” generally discloses a dieting plate arrangement utilizing a compartmentalized dish provided with compartments of predetermined fluid capacity consistent with dieting portions of weight-conscious individuals. The plate includes a further scale on one or more of the compartments for indication of quantity based upon varying density of fluid positioned within the compartments. A removable divider includes partition walls securable within the plate, wherein the partition walls may include walls formed of a hollow chamber, a fluid chamber, or a combination thereof to accommodate various dishes of various temperature radiance. A further embodiment includes a central hub formed with cylindrical recesses to accommodate cylindrical terminal ends of divider walls to enable selective division when the divider walls and central hub are positioned within the plate. More specifically, U.S. Pat. No. 4,966,295 discloses a dieting plate arrangement with movable partitions, wherein the partition walls may include walls formed of a hollow chamber, a fluid chamber, or a combination thereof to accommodate various dishes of various temperature radiance (FIGS. 1, 8, 9, Elements 33, 30, 32, 31; Claim 1; Column 3, Lines 49 to Column 4, Lines 62).

U.S. Pat. No. 4,877,119, issued on Oct. 31, 1989 to Hosking, entitled “Drinking-Beaker Assembly,” generally discloses an improved drinking-beaker assembly which serves as both a drinking vessel, especially the drinking of water in the course of a diet, and a device for determining the precise amount of liquid consumed. The assembly preferably includes a beaker, a snap-ring collar, indicia for the number of uses and indicia for the volume level within the beaker. The beaker has a base, a wall and an open top. Portions of the wall define an annular groove having an upper rib, a bight and a lower rib. The collar is snugly fitted within the groove for manual, axial rotation of the collar relative to the beaker. The collar further includes a window which is aligned with the use indicia to sequentially indicate the number of consumptive uses of the assembly. The user may fill the beaker to the level of the volume indicia, consume the liquid from the beaker and then rotate the collar with respect to the beaker so that the window exclusively displays the number of the indicia means associated with the use so that the total volume of liquid consumed is known.

U.S. Pat. No. 4,165,565, issued on Aug. 28, 1979 to Cloutier et al., entitled “Food Meter,” generally discloses a food meter comprising a base and four upstanding walls defining three spaces for the metering of spaghetti-like food. The spaces are generally in the form of troughs and are of graduated width for the selective metering of the food. A hole is, made in the base for hanging the instrument if so desired. FIG. 1, Elements 2, 3, 6, 9; Claim 1; Column 1, Lines 38 to Column 2, Lines 15. There is little disclosure to this system beyond the mere sizing of food containers.

U.S. Pat. No. 4,075,769, issued on Feb. 28, 1978 to Young, entitled “Method and Article for Weight Reduction,” generally discloses a method for weight reduction which permits a person to be served and eat as much food as he wants. The method centers around the concept of reducing each portion of food picked up with the utensil to a predetermined maximum size before placing it in the mouth. An article for use in conjunction with the method comprises a plate having a relatively large area for the meal and at least one smaller area alongside the large area to which the person eating must reduce each mouthful of food before it is ingested. More specifically, U.S. Pat. No. 4,075,769 discloses a plate for use with weight reduction technique, which comprises a marked area with which items of food are compared to allow user to eat only small portions (FIG. 3, Elements 16, 14, 18, 15; Claims 1, 2; Column 2, Lines 43 to Column 3, Lines 2). This does not appear to be a method that would gain widespread acceptance.

U.S. Patent Application No. 2009/0298021, published on Dec. 3, 2009 naming as inventors Black et al., entitled “Method and Apparatus for Identifying Dietary Choices,” generally discloses a method for assigning a relative score number to foods. Assignment of a relative score number to foods allows consumers to select foods that will provide a desirable diet. Equations are provided which are effective to yield a predicted raw score based on measured characteristics. The predicted raw score statistically correlates to a raw score that would be determined by an actual panel. The predicted raw scores are further processed to provide a relative score number that can be easily tracked by a consumer.

U.S. Patent Application No. 2009/0035734, published on Feb. 5, 2009 naming as inventors Highet et al., entitled “Incrementally-Sized Dishware System and Method of Using Same for Weight Management,” generally discloses an incrementally-sized dishware system and method for weight management that gradually modifies food portion consumption behavior to provide healthier eating habits. The incrementally-sized dishware system and method includes a plurality of incrementally-sized plates having successively differentiated plate surface areas. Each of the incrementally-sized plate surface areas is successively different by an increment to modify food portion delivery to a user. When utilizing the incrementally-sized dishware system and method a user selects a starting plate surface area based on a combination of weight management factors, and over time successively shifts to plates having smaller/larger plate surface areas. Interval changes between the dishes of the incrementally-sized dishware system and method adjust the amount of food consumed and rate of weight loss over time. Children using the incrementally-sized dishware system and method learn to recognize an appropriate meal size for their body size and weight, and establish healthy eating habits that carry into adulthood. More specifically, U.S. Patent Application No. 2009/0035734 discloses a dishware system for weight control, which comprises incrementally sized plates having successively differentiated plate surface areas, from which a user selects usage from a starting plate to a successive plate at designated time intervals (FIG. 2, Elements 11, 16, 13; Claims 1, 24; Paragraph [0031]). The system appears to rely on the visual effect of using successively smaller plates, cups, bowls and utensils to assist the user in consuming successively smaller portions of food and drink.

U.S. Patent Application No. 2008/0076096, published on Mar. 27, 2008 naming as inventor Thomas, entitled “Display for Visually Estimating Food Sizes,” discloses a display for visually estimating food portion sizes, which comprises an animal shaped figurine with predetermined legs and arms including label for identifying portion size that each leg and arm is equivalent to predetermined food portion size.

U.S. Patent Application No. 2003/0129570, published on Jul. 10, 2003 naming as inventor Alabaster, entitled “Method and System for Computerized Visual Behavior Analysis, Training and Planning,” generally discloses a display having each portion thereof equivalent to a predetermined food portion size for providing an individual with a visual reference to estimate an amount of food the individual is eating. The display includes at least one figurine having a body member with a predetermined shape. The body member includes a label for identifying a portion size that it is equivalent to. A head member, having a predetermined shape, is attached to the body member. The head member includes a label for identifying a portion size that it is equivalent to. A predetermined plurality of at least one of leg members and arm members, having a predetermined shape, are attached to the body member. Each one of the predetermined pluralities of at least one of leg members and arm members includes a label for identifying a portion size that each one is equivalent to. More specifically, U.S. Patent Application No. 2003/0129570 discloses a computerized meal planning system for training individuals to modify diet behavior, which comprises user interface, food and meal database with picture menu for displaying user interface meals to select from it (FIGS. 9, 10, Elements 120, 910; Claims 1, 2, 12, 13; Paragraphs [0036-0041]).

U.S. Pat. No. D 586,623, issued on Feb. 17, 2009 to Dunn, entitled “Portion Control Plate and Lid,” discloses a portion control plate and lid for dieters, which comprises dividers separating the plate into areas for apportioning food to the dieter.

U.S. Pat. No. D 443,176, issued on Jun. 5, 2001 to Strandberg, entitled “Top Surface of a Nutrition Plate,” discloses the top surface of a nutrition plate, which comprises the display of knowledge on the surface of the plate so that the user will be reminded about food groups and the dangers of overeating.

U.S. Pat. No. D 281,849, issued on Dec. 24, 1985 to Cantor, entitled “Diet Plate,” generally discloses a diet plate, which comprises a plate with dividers separating separate divisions of the plate for apportioning food to the plate and controlling diet (FIG. 1).

Thus, a problem associated with systems and methods for regulating caloric intake that precede the present invention is that they do not provide apparatus that makes it easy to select the appropriate serving sizes of food to achieve a desired caloric intake of foods consumed by a user.

Yet another problem associated with systems and methods for regulating caloric intake that precede the present invention is that they do not present readily available information to a user that facilitates a more reliable selection of foods to achieve a desired caloric distribution of foods to be consumed.

Still a further problem associated with systems and methods for regulating caloric intake that precede the present invention is that they fail to provide readily available information to a user that facilitates selecting a better assortment of foods, to keep the diet interesting while at the same time achieving a proper balance of food consumption from various food groups.

An additional problem associated with systems and methods for regulating caloric intake that precede the present invention is that they do not provide a single source of information from which more wise food selections can be made without conducting an undue amount of research.

Another problem associated with systems and methods for regulating caloric intake that precede the present invention is that they do not facilitate simple record-keeping that renders more likely the adherence to a proper diet designed to achieve a specific caloric intake goal.

An even further problem associated with systems and methods for regulating caloric intake that precede the present invention is that they are not as likely to be used on a regular basis, thereby undermining the likelihood of success in achieving the user's goals.

There is a demand, therefore, for systems and methods for regulating caloric intake that are more easily used and therefore more likely to be used.

### SUMMARY OF THE INVENTION

A system for regulating caloric intake is disclosed, along with a method for using the system. In a preferred embodiment, the system and method are adapted to making it easier for a user to maintain a diet, most often to enable weight loss. The system includes a collection of bowls to be used with respective food groups (e.g. meats, vegetables, fruits and grains), each sized to assist portion control and labeled to provide caloric content information for a selection of popular foods within a particular food group. The system can optionally include a glass sized to assist portion control and provided with a movable counter mechanism constructed and arranged to assist in monitoring water consumption. A booklet can optionally be provided to assist in determining the proper caloric intake for the user's goals, in total and for each food group. The booklet contains information regarding the desired total daily caloric intake based on the user's gender, age, activity level and goals (weight loss, weight gain, weight maintenance). A separate table provides data for guidance for selecting the proper daily caloric intake of foods within the various food groups, thereby assisting the user to maintain a balanced diet. A tablet or diary and pen can optionally be provided so the user can record information, as set forth in the system.

Thus, it is an object of the present disclosure to provide a system for regulating caloric intake and a method for using same that provides apparatus that makes it easy to select the appropriate serving sizes of food to achieve a desired caloric intake of foods consumed by a user.

Yet another object of the present disclosure is to provide a system for regulating caloric intake and a method for using same that presents readily available information to a user that facilitates a more reliable selection of foods to achieve a desired caloric distribution of foods to be consumed.

Still a further object of the present disclosure is to provide a system for regulating caloric intake and a method for using same that provides readily available information to a user that facilitates selecting a better assortment of foods, to keep the diet interesting while at the same time achieving a proper balance of food consumption from various food groups.

An additional object of the present disclosure is to provide a system for regulating caloric intake and a method for using same that provides a single source of information from which more wise food selections can be made without conducting an undue amount of research.

Another object of the present disclosure is to provide a system for regulating caloric intake and a method for using same that facilitates simple record-keeping that renders more likely the adherence to a proper diet designed to achieve a specific caloric intake goal.

An even further object of the present disclosure is to provide a system for regulating caloric intake and a method for using same that is likely to be used on a regular basis, thereby enhancing the likelihood of success in achieving the user's goals.

### BRIEF DESCRIPTION OF THE DRAWINGS

In the detailed description that follows, reference will be made to the following figures:

FIG. 1 is a perspective view of a portion of a preferred embodiment;

FIG. 2 is a perspective view of a portion of an alternative preferred embodiment illustrating components of the portion; and

FIG. 3 is a perspective view of the portion of the preferred embodiment shown in FIG. 2 illustrating some details of its intended usage.

### DETAILED DESCRIPTION OF PREFERRED EMBODIMENTS

A system for regulating caloric intake is disclosed, along with a method for using the system. In a preferred embodiment, the system and method are adapted to making it easier for a user to maintain a diet, most often to enable weight loss. The system includes a collection of dishes, e.g. bowls and/or plates, to be used with respective food groups (e.g. meats, vegetables, fruits and grains), each dish sized to assist portion control and labeled to provide caloric content information for a selection of popular foods within a particular food group. The system also includes a glass sized to assist portion control and provided with a movable counter mechanism constructed and arranged to assist in monitoring water consumption. A booklet is provided to assist in determining the proper caloric intake for the user's goals, in total and for each food group. The booklet contains information regarding the desired total daily caloric intake based on the user's gender, age, activity level and goals (weight loss, weight gain, weight maintenance). A separate table provides guidance for selecting the proper daily caloric intake of foods within the various food groups, assisting in maintaining a balanced diet. A tablet or diary and pen are provided so the user can record information, as set forth in the system.

Thus, the system provides information and apparatus to the user to facilitate a more likely-to-be-followed dieting regimen. In use, the user first consults information provided as a part of the system from which he or she can determine his or her desired total caloric intake. Next, the user consults information provided as a part of the system to determine the desired distribution, or allotment, of that caloric intake over various food groups.

The user then selects food quantities from the various food groups in accordance with the information thus provided. To make this step easier, the set of labeled bowls and plate are each provided with readily available information about the calorie content of commonly selected foods on the outside of each dish, and the dishes are sized to accommodate a proper food portion pertaining thereto.

To assist the user with water consumption (including the water contained within other common beverages), a glass or cup is provided and fitted with a counting mechanism. The user can move a count indicator to keep track of the liquid consumed per day.

Information used to construct the system of the preferred embodiment was obtained from the Pyramid distribution of nutrients. This information is available generally at www.mypyramid.gov, furnished by the U.S. Department of Agriculture Center for Nutrition Policy and Promotion (April 2005), and includes information about caloric demands for people of varying ages and activity levels, recommendations for food consumption from various food groups, and other helpful information.

### Determining a User's Desired Daily Caloric Intake

To know a user's desired daily caloric intake, the user first consults information provided as a part of the system from which he or she can determine his or her desired total caloric intake. The information provided helps the user determine the quantity of calories needed to maintain weight; if weight loss or gain is desired, one subtracts or adds 500 calories per day for every pound per week of weight change desired. Thus, depending on the user's age, gender and personal daily activity level, the table helps the user decide how many calories are needed in a day for weight maintenance.

TABLE 1
Daily Recommended Caloric Intake (to maintain current weight)

| | Sedentary | Active |
|---|---|---|
| Females | | |
| 2-3 years | 1,000 | 1,400 |
| 4-8 years | 1,200 | 1,800 |
| 9-13 | 1,600 | 2,200 |
| 14-18 | 1,800 | 2,400 |
| 19-30 | 2,000 | 2,400 |
| 31-50 | 1,800 | 2,200 |
| 51+ | 1,600 | 2,200 |
| Males | | |
| 2-3 years | 1,000 | 1,400 |
| 4-8 years | 1,400 | 2,000 |
| 9-13 | 1,800 | 2,600 |
| 14-18 | 2,200 | 3,200 |
| 19-30 | 2,400 | 3,000 |
| 31-50 | 2,200 | 3,000 |
| 51+ | 2,000 | 2,800 |

The calorie requirement for weight maintenance for each age/sex group is based on physical activity level, from sedentary to active. Sedentary generally means a lifestyle that includes only the light physical activity associated with typical day-to-day life. Active generally means a lifestyle that includes physical activity equivalent to walking more than three miles per day at three to four miles per hour, in addition to the light physical activity associated with typical day-to-day life.

### Determining a Healthy Food Selection to Meet the Desired Caloric Intake

The following information was obtained from MyPyramid, Steps to a Healthier You, a government source of food intake recommendations available at www.mypyramid.gov. Five food groups are defined as (1) grains, (2) vegetables, (3) fruits, (4) milk and (5) meats and beans. Food selection from these food groups is advised as follows and, accordingly, the system provides information from which these guidelines can be easily followed.

The grains group includes all foods made from wheat, rice, oats, corn meal, barley, such as bread, pasta, oatmeal, breakfast cereals, tortillas, and grits. In general, 1 slice of bread, 1 cup of ready-to-eat cereal, or ½ cup of cooked rice, pasta, or cooked cereal can be considered as 1 ounce equivalent from the grains group. At least half of all grains consumed should be whole grains. One is advised to eat at least 3 oz. of whole-grain cereals, breads, crackers, rice or pasta every day. One ounce is about one slice of bread, one cup of breakfast cereal, or half a cup of cooked rice, cereal or pasta. For a 2,000 calorie per day diet, one should consume six ounces from this food group.

The vegetable group includes all fresh, frozen, canned, and dried vegetables and vegetable juices. In general, 1 cup of raw or cooked vegetables or vegetable juice, or 2 cups of raw leafy greens can be considered as 1 cup from the vegetable group. Vegetable subgroup amounts are given in amounts to consume per week. One is advised to vary vegetable selection, and to select dark green vegetables such as broccoli, spinach, and other dark leafy greens, to select orange vegetables like carrots and sweet potatoes and to select dry beans and peas like pinto beans, kidney beans, and lentils. For a 2,000 calorie per day diet, one should consume two and one-half cups from this food group.

The fruit group includes all fresh, frozen, canned, and dried fruits and fruit juices. In general, 1 cup of fruit or 100% fruit juice, or ½ cup of dried fruit can be considered as 1 cup from the fruit group. From fruits, one is advised to select a variety. One should choose fresh, frozen, canned or dried fruits, and use fruit juices sparingly. For a 2,000 calorie per day diet, one should consume two cups from this food group.

The milk group includes all fluid milk products and foods made from milk that retain their calcium content, such as yogurt and cheese. Foods made from milk that have little to no calcium, such as cream cheese, cream, and butter, are not part of the group. In general, 1 cup of milk or yogurt, 1½ ounces of natural cheese, or 2 ounces of processed cheese can be considered as 1 cup from the milk group. One is advised to select these foods to ensure a sufficient intake of calcium. One should select low-fat or fat-free milk, yogurt, and other milk products. If one cannot consume milk because of dietary restrictions, one should select lactose-free products or other calcium sources such as fortified foods and beverages. For a 2,000 calorie per day diet, one should consume three cups from this food group. Children ages 2 to 8 should consume two cups from this group.

The meat & beans group includes meats, poultry, fish, eggs and beans. In general, 1 ounce of lean meat, poultry, or fish, 1 egg, 1 tbsp. peanut butter, ¼ cup cooked dry beans, or ½ ounce of nuts or seeds can be considered as 1 ounce equivalent from the meat and beans group. From meat and beans, one should select lean, protein rich foods, including low-fat or lean meats and poultry. Preferably, these are baked, broiled or grilled. One should vary the selection, by choosing from fish, beans, peas, nuts and seeds. For a 2,000 calorie per day diet, one should consume five and one-half ounces from this food group.

A discretionary calorie allowance grouping includes the remaining amount of calories in a food intake pattern, after accounting for the calories needed for all food groups using forms of foods that are fat-free or low-fat and with no added sugars. These can include healthier oils, such as fats from many different plants and from fish that are liquid at room temperature, such as canola, corn, olive, soybean, and sunflower oil. Some foods are naturally high in oils, like nuts, olives, some fish, and avocados. Foods that are mainly oil include mayonnaise, certain salad dressings, and soft margarine.

Following the foregoing recommendations regarding food distribution and desired daily caloric intake, the user consults information provided as a part of the system to determine the desired distribution, or allotment, of that caloric intake over various food groups. Thus, included with system is information in accordance with these guidelines.

The recommended quantity of food to consume from the basic food groups, subgroups, and oils is provided to meet recommended nutrient intakes at 12 different calorie levels (Table 2). Nutrient and energy contributions from each group are calculated according to the nutrient-dense forms of foods in each group (e.g., lean meats and fat-free milk). The table also shows the discretionary calorie allowance that can be accommodated within each calorie level (these numbers are provided as an approximation; exact calculations may differ).

TABLE 2
Recommended Food Distribution Data

| | | | | | | | | |
|---|---|---|---|---|---|---|---|---|
| Desired | 1,000 | | 1,200 | | 1,400 | | 1,600 | |
| Calories | | | | | | | | |
| Fruits | 1 | cup | 1 | cup | 1.5 | cup | 1.5 | cup |
| Vegetables | 1 | cup | 1.5 | cups | 1.5 | cups | 2 | cups |
| Grains | 3 | oz eq | 4 | oz eq | 5 | oz eq | 5 | oz eq |
| Meat/Beans | 2 | oz eq | 3 | oz eq | 4 | oz eq | 5 | oz eq |
| Milk | 2 | cups | 2 | cups | 2 | cups | 3 | cups |
| Oils | 3 | tsp | 4 | tsp | 4 | tsp | 5 | tsp |
| Discretionary | 165 | cals | 171 | cals | 171 | cals | 182 | cals |
| Desired | 1,800 | | 2,000 | | 2,200 | | 2,400 | |
| Calories | | | | | | | | |
| Fruits | 1.5 | cups | 2 | cups | 2 | cups | 2 | cups |
| Vegetables | 2.5 | cups | 2.5 | cups | 3 | cups | 3 | cups |
| Grains | 6 | oz eq | 6 | oz eq | 7 | oz eq | 8 | oz eq |
| Meat/Beans | 5 | oz eq | 5.5 | oz eq | 6 | oz eq | 6.5 | oz eq |
| Milk | 3 | cups | 3 | cups | 3 | cups | 3 | cups |
| Oils | 5 | tsp | 6 | tsp | 6 | tsp | 7 | tsp |
| Discretionary | 195 | cals | 267 | cals | 290 | cals | 362 | cals |
| Desired | 2,600 | | 2,800 | | 3,000 | | 3,200 | |
| Calories | | | | | | | | |
| Fruits | 2 | cups | 2.5 | cups | 2.5 | cups | 2.5 | cups |
| Vegetables | 3.5 | cups | 3.5 | cups | 4 | cups | 4 | cups |
| Grains | 9 | oz eq | 10 | oz eq | 10 | oz eq | 10 | oz eq |
| Meat/Beans | 6.5 | oz eq | 7 | oz eq | 7 | oz eq | 7 | oz eq |
| Milk | 3 | cups | 3 | cups | 3 | cups | 3 | cups |
| Oils | 8 | tsp | 8 | tsp | 10 | tsp | 11 | tsp |
| Discretionary | 410 | cals | 426 | cals | 512 | cals | 648 | cals |

Of course, the foregoing data is general. More precise calorie-counting requires knowing the caloric content by volume or weight of specific foods selected from the above-named food groups. These are available as follows.

TABLE 3
Specific Caloric Content of Common Foods
Table 3A: Serving Calorie Content - Fruits

| | | | | |
|---|---|---|---|---|
| Apples (chopped) | 1 | cup | 65 | calories |
| Bananas (mashed) | 1 | cup | 200 | calories |
| Oranges (sections) | 1 | cup | 85 | calories |
| Grapes | 1 | cup | 62 | calories |
| Melon - cantaloupe | 1 | cup (balls) | 60 | calories |
| Watermelon | 1 | cup (balls) | 46 | calories |
| Peaches (slices) | 1 | cup | 66 | calories |
| Blueberries | 1 | cup | 83 | calories |
| Pineapple (diced) | 1 | cup | 78 | calories |
| Pears (slices) | 1 | cup | 96 | calories |
| Plums (slices) | 1 | cup | 76 | calories |
| Nectarines (slices) | 1 | cup | 61 | calories |
| Avocados (cubes) | 1 | cup | 240 | calories |
| Cherries (sweet) | 1 | cup (w/pits) | 74 | calories |
| Mangos (slices) | 1 | cup | 107 | calories |
| Raspberries | 1 | cup | 64 | calories |
| Strawberries (frozen, unsweetened) | 1 | cup | 77 | calories |
| Tangerine | 1 | cup | 103 | calories |
| Honeydew | 1 | cup (balls) | 64 | calories |
| Blackberries | 1 | cup | 62 | calories |
| Blueberries (frozen, unsweetened) | 1 | cup | 79 | calories |
| Apricots (halves) | 1 | cup | 74 | calories |
| Papayas (cubes) | 1 | cup | 55 | calories |
| Figs | 1 | large | 47 | calories |
| Pomegranate | 1 | medium | 105 | calories |
| Kiwi | 1 | medium | 100 | calories |

Table 3B: Serving Calorie Content - Vegetables

| | | | | |
|---|---|---|---|---|
| Cauliflower (boiled) | 1 | cup | 28 | calories |
| Celery (diced) | 1 | cup | 19 | calories |
| Corn (sweet and yellow) | 1 | cup | 132 | calories |
| Peppers (sweet, red) | 1 | cup | 46 | calories |
| | | (chopped) | | |
| Mushrooms (slices) | 1 | cup | 15 | calories |
| Cabbage (chopped) | 1 | cup | 22 | calories |
| Asparagus | 1 | cup | 27 | calories |
| Carrots (chopped) | 1 | cup | 52 | calories |
| Radishes (slices) | 1 | cup | 19 | calories |
| Spinach (raw) | 1 | cup | 7 | calories |
| Cucumbers | 1 | cup | 16 | calories |
| Cherry tomatoes | 1 | cup | 27 | calories |
| Lettuce (shredded) | 1 | cup | 8 | calories |
| Onions (chopped) | 1 | cup | 64 | calories |
| Potatoes (boiled) | 1 | cup | 136 | calories |
| Potatoes (baked) | 1 | large | 281 | calories |
| Green beans (frozen) | 1 | cup | 40 | calories |
| Mixed vegetables (frozen) | 1 | cup | 143 | calories |
| Broccoli | 1 | cup | 100 | calories |
| Brussels sprout (cooked) | 1 | cup | 65 | calories |
| Green peas (raw) | 1 | cup | 117 | calories |
| Green peas (frozen, cooked) | 1 | cup | 158 | calories |
| Sugar snaps | 1 | cup | 50 | calories |
| Shelled Edamame (frozen) | 1 | cup | 180 | calories |

Table 3C: Serving Calorie Content - Grains (and Sugars)

| | | | | |
|---|---|---|---|---|
| Sugar (granulated) | 1 | tbsp | 16 | calories |
| Sugar (brown) | 1 | tbsp | 11 | calories |
| NutraSweet (Equal) | 1 | packet | 3.5 | calories |
| Instant oat cereal | 1 | cup (cooked) | 138 | calories |
| Wheat flour, bleached | 1 | cup | 455 | calories |
| Rice noodles | 1 | cup | 192 | calories |
| Rice, white, long grain (cooked) | 1 | cup | 205 | calories |
| Barley, cooked | 1 | cup | 193 | calories |
| Spaghettis, cooked, unenriched | 1 | cup | 221 | calories |
| Average white bread | 1 | slice | 100 | calories |
| Average brown bread | 1 | slice | 82 | calories |

| | | | |
|---|---|---|---|
| Hamburger or hot dog bun, plain | one | 84 | calories |
| Dinner roll, plain | one | 84 | calories |
| 6″ Italian white | one | 200 | calories |
| 6″ nine grains wheat | one | 210 | calories |
| Bagel, whole grain | one | 350 | calories |
| Bagel, white | one | 354 | calories |
| Pita bread, white (4″ diameter) | one | 77 | calories |
| Pita bread, whole wheat | one | 74 | calories |
| 4″ diameter) | | | |
| Croissant, butter | one | 272 | calories |

Table 3D: Serving Calorie Content - Meat and Beans

| | | | | |
|---|---|---|---|---|
| Ham (lean roasted) | 6 | oz | 384 | calories |
| Bologna (beef or pork) | 6 | oz | 450 | calories |
| Ground beef (lean, broiled) | 6 | oz | 459 | calories |
| Beef sirloin steak (lean, broiled) | 6 | oz | 360 | calories |
| Beef T-bone steak (lean and broiled) | 6 | oz | 365 | calories |
| Beef porterhouse steak (lean, broiled) | 6 | oz | 371 | calories |
| Chicken breast (skinless/roasted) | 6 | oz | 247 | calories |
| Chicken leg (skinless/roasted) | 6 | oz | 273 | calories |
| Chicken thigh (skinless/roasted) | 6 | oz | 164 | calories |
| Turkey (white meat) (roasted) | 6 | oz | 254 | calories |
| Turkey (dark meat) (roasted) | 6 | oz | 192 | calories |
| Turkey/chicken (deli style) | 6 | oz | 174 | calories |
| Lamb rib (roasted) | 6 | oz | 630 | calories |
| Lamb leg (roasted) | 6 | oz | 410 | calories |
| Hummus | 1 | cup | 435 | calories |
| Chickpeas | 1 | cup | 286 | calories |
| Kidney beans, canned | 1 | cup | 215 | calories |
| Fava beans (cooked) | 1 | cup | 187 | calories |
| Lima beans (cooked) | 1 | cup | 209 | calories |
| Black beans (cooked) | 1 | cup | 227 | calories |
| Small white beans (boiled) | 1 | cup | 254 | calories |
| Soy beans (boiled) | 1 | tbsp | 19 | calories |
| Soy beans (roasted) | 1 | cup | 810 | calories |
| Lentils (boiled) | 1 | cup | 226 | calories |

Table 3E: Serving Calorie Content - Milk

| | | | | |
|---|---|---|---|---|
| Cheese cheddar | 2 | oz | 229 | calories |
| Cheese American | 1 | sl (¾ oz) | 79 | calories |
| Cheese cream | 1 | tbsp | 51 | calories |
| Cheese provolone | 1 | slice | 100 | calories |
| Cheese brie | 2 | oz | 95 | calories |
| Vanilla ice cream | 4 | oz | 265 | calories |
| Vanilla ice cream (low fat) | 4 | oz | 184 | calories |
| Whipped cream (pressurized) | 1 | tbsp | 8 | calories |
| Chocolate ice cream | 4 | oz | 285 | calories |
| Cream (Half & Half) | 1 | tbsp | 20 | calories |
| Light cream (coffee cream) | 1 | tbsp | 29 | calories |
| Yogurt plain (low fat) | 1 | cup | 154 | calories |
| Yogurt fruit | 1 | cup | 243 | calories |
| Milk (non fat) | 1 | cup | 86 | calories |
| Milk (1%) | 1 | cup | 103 | calories |
| Milk (2%) | 1 | cup | 122 | calories |
| Milk chocolate (low fat) | 1 | cup | 158 | calories |
| Milk shake (vanilla) | 4 | oz | 127 | calories |
| Milk shake (chocolate) | 4 | oz | 135 | calories |
| Frozen yogurt (vanilla) | 1 | cup | 229 | calories |
| Frozen yogurt (chocolate) | 1 | cup | 230 | calories |

Table 3F: Serving Calorie Content - Snacks

| | | | | |
|---|---|---|---|---|
| Raisins (seedless) | 1 | cup | 493 | calories |
| Almond (raw) | ¼ | cup | 180 | calories |
| Peanuts (dry/roasted) | 1 | oz | 166 | calories |
| Almond (dry/roasted) | 1 | cup | 206 | calories |
| Pistachios (dry roasted) | 1 | cup | 182 | calories |
| Pine nuts (dried) | ¼ | cup | 229 | calories |
| Walnuts (raw) | ¼ | cup | 210 | calories |
| Sunflowers | ½ | cup | 135 | calories |
| Cashews (dry roasted) | ¼ | cup | 197 | calories |
| Pretzels (classic twists) | ¼ | cup | 220 | calories |
| Rice cakes (brown, plain) | 1 | cake | 35 | calories |
| Fruit snacks | 1 | pouch | 78 | calories |
| Jell-O (strawberry gelatin) | 1 | cup | 28 | calories |
| Fiber one bar (oat and chocolate) | 1 | bar | 140 | calories |
| Kashi cereal bar (blkbry graham) | 1 | bar | 110 | calories |
| Special K (choc delight bar) | 1 | bar | 110 | calories |
| Special K (blueberry cereal bar) | 1 | bar | 90 | calories |
| Popcorn (air popped) | 1 | cup | 31 | calories |
| Popcorn (oil popped) | 1 | cup | 64 | calories |
| Cranberry dried | ¼ | cup | 130 | calories |
| Cherries (dried) | ¼ | cup | 130 | calories |
| Apricot (dried) | ¼ | cup | 110 | calories |
| Blueberry (dried) | ¼ | cup | 140 | calories |
| Pineapple chunks (dried) | ¼ | cup | 140 | calories |
| Papaya (dried) | 5 | pieces | 140 | calories |
| Mangos (dried) | 3 | pieces | 160 | calories |
| Plums (dried) | 5 | prunes | 110 | calories |

Table 3G: Serving Calorie Content - Beverages

| Coffee Black | 1 | cup | 5 | calories |
|---|---|---|---|---|
| Hot tea (1 bag) | 1 | cup | 0 | calories |
| Iced tea (sweetened) | 1 | cup | 70 | calories |
| Iced tea (unsweetened) | 1 | cup | 0 | calories |
| Cafe late (non fat milk) | tall | | 126 | calories |
| Espresso | 1 | oz | 1 | calorie |
| Cappuccino (non-fat milk) | tall | | 75 | calories |
| Mocha (non-fat milk, w/o cream) | tall | | 174 | calories |
| Soy milk (vanilla) | 1 | cup | 100 | calories |
| Soy milk (plain) | 1 | cup | 132 | calories |
| Cola (Coca-cola Classic) | 1 | cup | 97 | calories |
| Vegetable juice (V8) | 1 | cup | 50 | calories |
| Diet cola (Diet Coke) | 1 | cup | 1 | calories |
| Beer, regular | 12 | oz | 153 | calories |
| Beer, light | 12 | oz | 103 | calories |
| Whiskey, gin, rum, vodka | 1 | oz | 64 | calories |
| Wine (table red) | 1 | glass | 85 | calories |
| Wine (table white) | 1 | glass | 84 | calories |
| Orange juice | 1 | cup | 112 | calories |
| Apple juice | 1 | cup | 117 | calories |
| Cranberry juice | 1 | cup | 130 | calories |
| light cranberry juice | 1 | cup | 16 | calories |
| Iced tea (sweetened) | 1 | cup | 70 | calories |
| Herb tea | 1 | cup | 2 | calories |
| Flavored water | 1 | cup | 0 | calories |
| Water (tap) | 1 | cup | 0 | calories |
| Sparkling water (san Pellegrino) | 1 | bottle | 0 | calories |
| Flavored (san Pellegrino orange) | 1 | can | 160 | calories |
| Flavored (san Pellegrino lemon) | 1 | can | 180 | calories |
| Vitamin water (revive) | 1 | cup | 50 | calories |
| Vitamin water (power C) | 1 | cup | 50 | calories |
| Vitamin water (B-relaxed) | 1 | cup | 50 | calories |

Thus, a great deal of information is presented in the system from which an optimal allotment of calories can be gleaned. The user can determine his or her desired daily caloric intake using the data provided in Table 1, determine the distribution of foods from recommended food groups needed to achieve that desired daily caloric intake using the data provided in Table 2, and select foods to be consumed accordingly, using the data provided in Table 3. The user thus determines how many calories should be consumed from each food category, adds the caloric intake for that day, and determines whether the proposed diet is within the recommended range of calories.

To make the system more readily used, however, additional apparatus can be provided. In the more preferred embodiment, labeled bowls and a plate are provided to assist with portion control and make a subset of data quickly and readily available to the user. Thus, as described below, five bowls and one plate are labeled as follows.

Bowl 1 (Snacks 2 oz)

| | | | |
|---|---|---|---|
| 1. | Sunflower seeds (roasted) | 2 oz | 186 calories |
| 2. | Peanuts (roasted) | 2 oz | 332 calories |
| 3. | Pistachios (roasted) | 2 oz | 182 calories |
| 4. | Cashews (roasted) | 2 oz | 330 calories |
| 5. | Almond (roasted) | 2 oz | 328 calories |
| 6. | Mixed nuts (roasted) | 2 oz | 350 calories |

Bowl 2 (Snacks 4 Oz)

| | | | |
|---|---|---|---|
| 1. | Raisins | 4 oz | 336 calories |
| 2. | Cranberries dried | 4 oz | 348 calories |
| 3. | Apricots dried | 4 oz | 272 calories |
| 4. | Skim milk | 4 oz | 45 calories |
| 5. | Popcorn (air popped) | 4 oz | 16 calories |
| 6. | Pretzels | 4 oz | 440 calories |
| 7. | Popcorn (oil popped) | 4 oz | 32 calories |
| 8. | Yogurt (fat free) | 4 oz | 69 calories |

Bowl 3 (Grain and Beans 1 Cup (8 oz))

| | | | |
|---|---|---|---|
| 1. | Lentils cooked | 1 cup | 212 calories |
| 2. | Fava Beans | 1 cup | 187 calories |
| 3. | Chick peas | 1 cup | 269 calories |
| 4. | Lima beans | 1 cup | 209 calories |
| 5. | Black beans | 1 cup | 227 calories |
| 6. | Kidney beans | 1 cup | 218 calories |
| 7. | Rice Brown | 1 cup | 218 calories |
| 8. | Rice white cooked | 1 cup | 205 calories |
| 9. | Pasta white cooked | 1 cup | 176 calories |
| 10. | Pasta wheat cooked | 1 cup | 179 calories |
| 11. | Oatmeal | 1 cup | 133 calories |

Bowl 4 (fruits 1.5 cup (12 oz))

| | | | |
|---|---|---|---|
| 1. | Strawberries | 1.5 cup | 68 calories |
| 2. | Orange | 1.5 cup | 128 calories |
| 3. | Cantaloupe | 1.5 cup | 84 calories |
| 4. | Banana | 1.5 cup | 300 calories |
| 5. | Apple | 1.5 cup | 98 calories |
| 6. | Grapes | 1.5 cup | 93 calories |
| 7. | Watermelon | 1.5 cup | 69 calories |
| 8. | Pear | 1.5 cup | 144 calories |
| 9. | Blueberry | 1.5 cup | 125 calories |
| 10. | Peach | 1.5 cup | 99 calories |
| 11. | Mango | 1.5 cup | 161 calories |
| 12. | Pineapple | 1.5 cup | 117 calories |

Bowl 5 (Vegetables 2 Cups (16 oz))

| | | | |
|---|---|---|---|
| 1. | Lettuce | 2 cups | 14 calories |
| 2. | Cucumber sliced | 2 cups | 32 calories |
| 3. | Carrots sliced | 2 cups | 96 calories |
| 4. | Cabbage shredded | 2 cups | 34 calories |
| 5. | Broccoli | 2 cups | 80 calories |
| 6. | Corn cooked | 2 cups | 280 calories |
| 7. | Mushrooms | 2 cups | 40 calories |
| 8. | Peas cooked | 2 cups | 230 calories |
| 9. | Green beans cooked | 2 cups | 62 calories |
| 10. | Onion | 2 cups | 52 calories |
| 11. | Sugar snaps | 2 cups | 100 calories |
| 12. | Tomatoes | 2 cups | 82 calories |
| 13. | Spinach | 2 cups | 28 calories |
| 14. | Coleslaw w/dressing | 2 cups | 238 calories |

Plate 6 (Meat 6 oz)

| | | | |
|---|---|---|---|
| 1. | Ham (lean roasted) | 6 oz | 384 calories |
| 2. | Bologna (beef or pork) | 6 oz | 450 calories |
| 3. | Ground beef (lean, broiled) | 6 oz | 459 calories |
| 4. | Beef sirloin steak (lean, | 6 oz | 360 calories |
| | broiled) | | |
| 5. | Beef T-bone steak | 6 oz | 365 calories |
| | (lean and broiled) | | |
| 6. | Beef porterhouse steak | 6 oz | 371 calories |
| | (lean and broiled) | | |
| 7. | Chicken breast | 6 oz | 247 calories |
| | (skinless/roasted) | | |
| 8. | Chicken leg | 6 oz | 273 calories |
| | (skinless/roasted) | | |
| 9. | Chicken thigh | 6 oz | 164 calories |
| | (skinless/roasted) | | |
| 10. | Turkey (white meat) | 6 oz | 254 calories |
| | (roasted) | | |
| 11. | Turkey (dark meat) | 6 oz | 192 calories |
| | (roasted) | | |
| 12. | Turkey/chicken | 6 oz | 174 calories |
| | (deli style) | | |
| 13. | Lamb rib (roasted) | 6 oz | 630 calories |
| 14. | Lamb leg (roasted) | 6 oz | 410 calories |

In an even more preferred embodiment, a glass or cup is provided with a counting mechanism, including a movable count indicator to permit a user to keep track of how many portions of liquid have been consumed. This can be provided by using a numbered elastic band that wraps around any desired cup or glass. The band helps the user keep track of how many cups of water consumed during the day. Eight cups a day is recommended; this is considered healthy and also assists when limiting food intake to accomplish weight loss, as water consumption prior to eating helps a user feel more satisfied with a smaller food portion than he or she otherwise would. Each time the user drinks a cup, the user moves the indicator to the correct number of cups consumed until reaching their goal for the day (8 cups), in accordance with the disclosure provided.

Thus, in a general sense, a system for regulating caloric intake is disclosed, along with a method for using the system. The system and method can be adapted to assist a user to maintain a diet, most often to enable weight loss. The system can include a collection of specially labeled bowls and plates to be used with respective food groups (e.g. meats, vegetables, fruits and grains), each sized to assist portion control and labeled to provide caloric content information for a selection of popular foods within a particular food group. The system can also include a glass sized to assist portion control, further having a movable counter mechanism constructed and arranged to assist in monitoring water consumption. A booklet can be provided to assist in determining the proper caloric intake for the user's goals, in total and for each food group. The booklet contains information regarding the desired total daily caloric intake based on the user's gender, age, activity level and goals (weight loss, weight gain, weight maintenance). A separate table provides guidance for selecting the proper daily caloric intake of foods within the various food groups, assisting in maintaining a balanced diet. A tablet or diary and pen are provided so the user can record information, as set forth in the system.

In a more specific sense, the present disclosure is directed to a system for regulating caloric intake, along with a method for using the system. The system includes bowls, including one flat, shallow bowl (or plate), each labeled with data regarding the caloric content of commonly selected foods. In a more preferred embodiment, the bowls are sized to receive a preferred portion size of food, and selectively labeled to provide information about the food that is organized into various food groups. In a yet more preferred embodiment, a fill line is provided on the inside of the bowl to facilitate more precise food consumption by volume. In an even more preferred embodiment, readily available data regarding a user's daily caloric needs is included. In an even more preferred embodiment, a glass or cup is included and provided with a counting mechanism constructed and arranged to permit a user to monitor his or her daily consumption of a liquid, e.g. water.

Referring now to a specific, preferred embodiment, the system includes a set of labeled dishes 110, 120, 130, 140 150 and 160, a count-recording drinking apparatus 200, a data-containing apparatus 300 and a data-recordable apparatus 400.

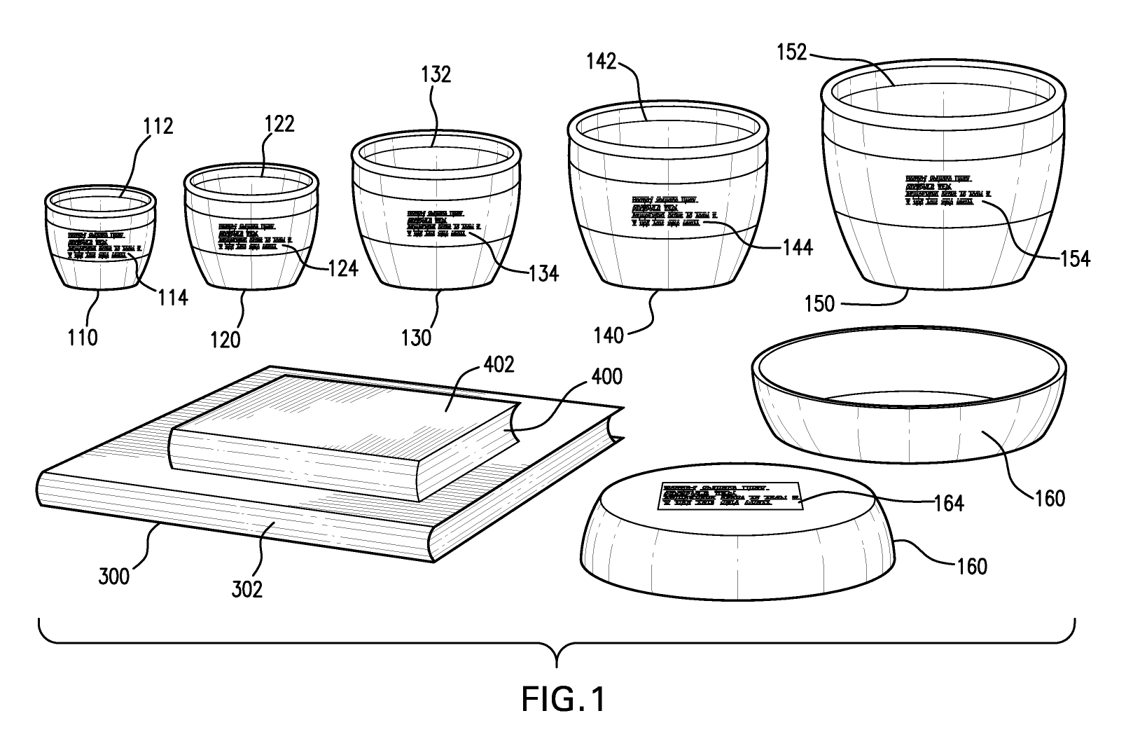

As shown in FIG. 1, the set of labeled dishes includes five bowls of varying sizes and one flat bowl, or plate, each labeled to provide the caloric content of commonly desired foods from given food groups. The dishes are sized to be stackable, thus facilitating portability, storage and more likely usage. A first bowl 110 is sized to receive an appropriate portion of calorie-dense foods, such as nuts and seeds, in the food group including snacks, e.g. two ounces. The bowl 110 is preferably larger than the portion to be placed in it, and a fill line 112 is placed inside the bowl 110 so that the volume of the bowl 110 below the fill line 112 is two ounces. A first bowl label portion 114 is positioned on the outside of the first bowl 110 and provides information about the calories contained in calorie-dense foods, such as nuts and seeds, (a) commonly selected from the food group including snacks that (b) would substantially fill the bowl, e.g. two ounces. To facilitate the ability to provide more information on the outside of the bowl, the first bowl label portion 114 can occupy two panels on the bowl 110, the first illustrated at 114 and the second being disposed 180 degrees from the first, or on the back of the bowl as it is positioned in FIG. 1 (the second panel thereby not shown in FIG. 1). The list of data appearing within the first bowl label portion 114 is shown above, under the heading Bowl 1 (snacks 2 oz).

A second bowl 120 is provided, and sized to receive an appropriate portion of less calorie-dense food in the food group including snacks, e.g. four ounces. The bowl 120 is preferably larger than the portion to be placed in it, and a fill line 122 is placed inside the bowl 120 so that the volume of the bowl 120 below the fill line 122 is four ounces. A second bowl label portion 124 is positioned on the outside of the second bowl 120 and provides information about the calories contained in less calorie-dense foods (a) commonly selected from the food group including snacks that (b) would substantially fill the bowl, e.g. four ounces. To facilitate the ability to provide more information on the outside of the bowl, the second bowl label portion 124 can occupy two panels on the bowl 120, the first illustrated at 124 and the second being disposed 180 degrees from the first, or on the back of the bowl as it is positioned in FIG. 1 (the second panel thereby not shown in FIG. 1). The list of data appearing within the second bowl label portion 124 is shown above, under the heading Bowl 2 (snacks 4 oz).

In similar fashion, a third bowl 130 is sized to receive an appropriate portion of food in the food group including grain and beans, e.g. one cup (8 oz.). The bowl 130 is preferably larger than the portion to be placed in it, and a fill line 132 is placed inside the bowl 130 so that the volume of the bowl 130 below the fill line 132 is 8 oz. A third bowl label portion 134 is positioned on the outside of the third bowl 130 and provides information about the calories contained in foods (a) commonly selected from the food group including grain and beans that (b) would substantially fill the bowl, e.g. one cup. To facilitate the ability to provide more information on the outside of the bowl, the third bowl label portion 134 can occupy two panels on the bowl 130, the first illustrated at 134 and the second being disposed 180 degrees from the first, or on the back of the bowl as it is positioned in FIG. 1 (the second panel thereby not shown in FIG. 1). The list of data appearing within the third bowl label portion 132 is shown above, under the heading Bowl 3 (Grains and Beans 1 cup).

Likewise, a fourth bowl 140 is sized to receive an appropriate portion of food in the food group including fruits, e.g. one and one-half cups (12 oz.). The bowl 140 is preferably larger than the portion to be placed in it, and a fill line 142 is placed inside the bowl 140 so that the volume of the bowl 140 below the fill line 142 is 12 oz. A fourth bowl label portion 144 is positioned on the outside of the third bowl 140 and provides information about the calories contained in foods (a) commonly selected from the food group including fruits that (b) would substantially fill the bowl, e.g. one and one-half cups (12 oz.). To facilitate the ability to provide more information on the outside of the bowl, the fourth bowl label portion 144 can occupy two panels on the bowl 140, the first illustrated at 144 and the second being disposed 180 degrees from the first, or on the back of the bowl as it is positioned in FIG. 1 (the second panel thereby not shown in FIG. 1). The list of data appearing within the fourth bowl label portion 144 is shown above, under the heading Bowl 4 (Fruits 1.5 cup).

In similar fashion, a fifth bowl 150 is sized to receive an appropriate portion of food in the food group including vegetables, e.g. two cups (16 oz.). The bowl 150 is preferably larger than the portion to be placed in it, and a fill line 152 is placed inside the bowl 150 so that the volume of the bowl 150 below the fill line 152 is 16 oz. A fifth bowl label portion 154 is positioned on the outside of the fifth bowl 150 and provides information about the calories contained in foods (a) commonly selected from the food group including vegetables that (b) would substantially fill the bowl, e.g. two cups (16 oz.). To facilitate the ability to provide more information on the outside of the bowl, the fifth bowl label portion 154 can occupy two panels on the bowl 150, the first illustrated at 154 and the second being disposed 180 degrees from the first, or on the back of the bowl as it is positioned in FIG. 1 (the second panel thereby not shown in FIG. 1). The list of data appearing within the fifth bowl label portion 154 is shown above, under the heading Bowl 5 (Vegetables 2 cups).

Finally, a sixth bowl or plate 160 is sized to receive an appropriate portion of food in the food group including meat, e.g. six ounces by weight. This bowl or plate 160 is flattened in shape relative to the other bowls 110, 120, 130, 140 and 150. A plate label portion 164 is positioned on the bottom of the plate 160 and provides information about the calories contained in foods (a) commonly selected from the food group including meat that (b) would substantially cover the bottom of the plate 160, e.g. six ounces by weight. The list of data appearing within the plate label portion 164 is shown above, under the heading Plate 6 (meat 6 oz).

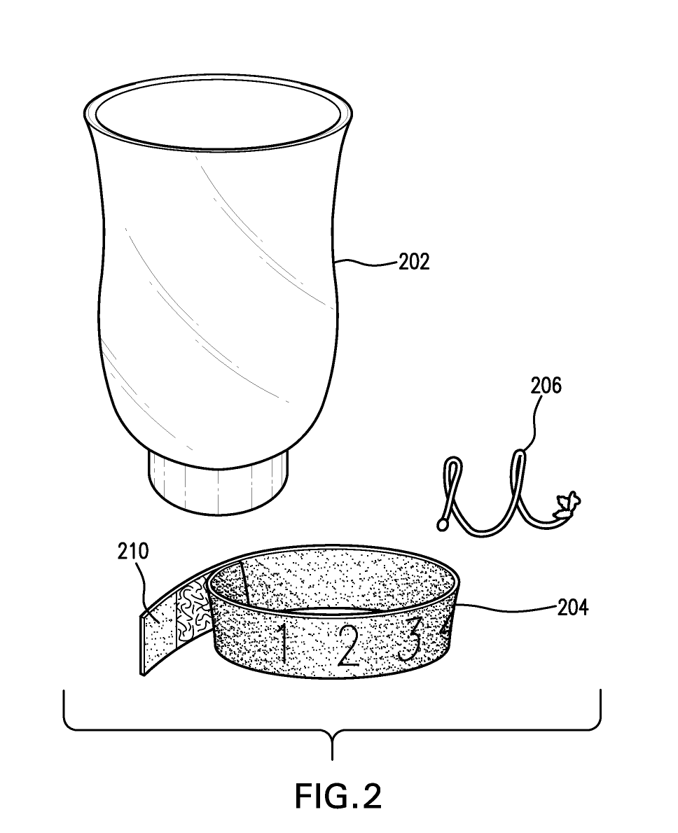

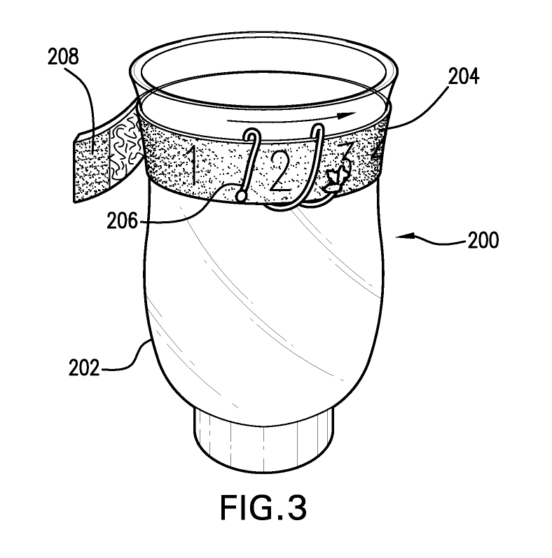

Referring now to FIGS. 2 and 3, a count-recording drinking apparatus 200 is shown. The apparatus includes a glass 202 provided with an elastic count recorder 204 fitted with a count marking clip 206. The elastic count recorder 204 is positioned around the glass 202 and is numbered with integers from 1 to 8. A Velcro-like detachable pad 208 (shown in FIG. 3) and receiver 210 (shown in FIG. 2) provide additional adjustability to the count recorder 204; each of these is disposed at one of two distal ends of the count recorder 204 and can be positioned in either order. Thus, either the pad 208 is positioned at the end of the recorder 204 away from the integer 1, as in FIG. 3, or the receiver 210 is positioned at the end of the recorder 204 away from the integer 1, as shown in FIG. 2. The clip 206 is slidably mounted on the count recorder 204 and is positionable over a selected integer, thereby providing a method for keeping track of the number of glasses of liquid consumed by the user. The band provides apparatus to assist a user in keeping track of how many cups of water he or she consumed during the day. Eight cups a day is recommended; this is considered healthy and also assists when limiting food intake to accomplish weight loss, as water consumption prior to eating helps a user feel more satisfied with a smaller food portion than he or she otherwise would.

Referring now again to FIG. 1, a data-containing apparatus 300 comprising a data-containing notebook 302 is shown. The notebook contains additional information to assist a user in determining his or her desired daily food and liquid intake. For example, the notebook 302 contains data regarding a user's estimated daily calorie needs, or those calories required to maintain a current body weight. These data are organized by the user's age, sex and activity level, and are shown in Table 1, above.

The notebook 302 also includes information regarding the desired distribution of calories to be consumed among the various food groups. Thus, once a user knows the desired number of calories to be consumed per day, the user can determine the appropriate distribution of calories in each food group by consulting the notebook 302. These data are organized by the number of calories to be consumed per day, and are shown in Table 2, above. Additionally, the notebook 302 includes a great deal of information regarding caloric content of foods and beverages, as shown in Table 3, above.

The system can also be provided with a data-recordable apparatus 400 including a note pad 402 and a pen or pencil (not shown). These can be provided to permit a user to record personal information regarding their efforts, including variances from the desired goals and other such information.

To use the system, the user first consults the data-containing apparatus 400, including Table 1, to determine his or her desired total caloric intake. Next, the user consults the data-containing apparatus 400, including Table 2, to determine the distribution, or allotment, of that caloric intake over the various food groups. Next, the user selects foods from the various food groups, preferably from the list of foods shown on one or more of the assorted label portions 114, 124, 134, 144, 154 and 164 positioned on the bowls 110, 120, 130, 140, 150 and plate 160. The user then selects from those food groups desired portions that provide the desired distribution, or allotment, of the desired caloric intake over the various food groups. Finally, the user fills one or more of the bowls 110, 120, 130, 140, 150 and plate 160, as appropriate, to provide the desired amount of food from the selected food groups for consumption.

It can be appreciated that the system is more likely to be used by a user if information is made available to the user in a format that requires a minimum of effort to locate. Additionally, sizing the dishes, e.g. bowls and plate, to accommodate the amount of food desired and yet appear to be substantially filled with the amount of food desired, assists the user in obtaining the visual effect of a larger, fuller portion. Moreover, assisting the user in consumption of water, especially by encouraging the consumption of eight 8-ounce glasses of water per day, helps the user feel full, remain hydrated and otherwise achieve optimal health. Finally, sizing and shaping the dishes to be stackable and more easily shipped, stored in the home, transported around the home and packed for taking with the user is desired, to again facilitate not only using the system but sticking to the desired diet to achieve the user's goals.

The described embodiments are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

What is claimed is:

1. A system for regulating caloric intake comprising, in combination:
a plurality of labeled dishes;
each dish sized to receive approximately a predetermined, desired volume of food selected from a food group; and
each dish having a label portion positioned on the outer portion of the dish and having written information about the caloric content per predetermined, desired volume of a plurality of foods selected from the food group.

2. The system of claim 1, further comprising a count-recording drinking apparatus including a count recorder numbered with integers from 1 to 3 and adapted to fit around the outside of a glass, the count recorder having a count marking assembly selectively positionable over each of the integers.

3. The system of claim 1, further comprising a data-containing assembly having information regarding a daily caloric intake required to maintain a user's weight.

4. The system of claim 1, further comprising a data-containing assembly having information regarding a desired distribution of a quantity of calories to be consumed among various food groups.

5. The system of claim 3, wherein the data-containing assembly further has information regarding a desired distribution of a quantity of calories to be consumed among various food groups.

6. The system of claim 2, further comprising a data-containing assembly having information regarding a daily caloric intake required to maintain a user's weight.

7. The system of claim 2, further comprising a data-containing assembly having information regarding a desired distribution of a quantity of calories to be consumed among various food groups.

8. The system of claim 6, wherein the data-containing assembly further has information regarding a desired distribution of a quantity of calories to be consumed among various food groups.

9. A system for regulating caloric intake comprising, in combination:
a plurality of labeled dishes having a first bowl, a second bowl, a third bowl, a fourth bowl, a fifth bowl and a plate;
a count-recording drinking apparatus; and
a data-containing apparatus;
the first bowl sized to receive approximately two ounces of food selected from a food group including nuts and seeds, the first bowl further having a first bowl label portion positioned on the outer portion of the first bowl, the first bowl label portion having written information about the caloric content per two ounces of a plurality of foods selected from the food group including nuts and seeds;
the second bowl sized to receive approximately four ounces of food selected from a food group including snacks, the second bowl further having a second bowl label portion positioned on the outer portion of the second bowl, the second bowl label portion having written information about the caloric content per four ounces of a plurality of foods selected from the food group including snacks;
the third bowl sized to receive approximately one cup of food selected from a food group including grain and beans, the third bowl further having a third bowl label portion positioned on the outer portion of the third bowl, the third bowl label portion having written information about the caloric content per one cup of a plurality of foods selected from the food group including grain and beans;
the fourth bowl sized to receive approximately one and one-half cups of food selected from a food group including fruits, the fourth bowl further having a fourth bowl label portion positioned on the outer portion of the fourth bowl, the fourth bowl label portion having written information about the caloric content per one and one-half cups of a plurality of foods selected from the food group including fruits;
the fifth bowl sized to receive approximately two cups of food selected from a food group including vegetables, the fifth bowl further having a fifth bowl label portion positioned on the outer portion of the fifth bowl, the fifth bowl label portion having written information about the caloric content per two cups of a plurality of foods selected from the food group including vegetables;
the plate sized to receive approximately six ounces of food selected from a food group including meat, the plate further having a plate label portion positioned on the outside of the plate, the plate label portion having written information about the caloric content per six ounces of a plurality of foods selected from the food group including meat;
the count-recording drinking apparatus including an elastic count recorder numbered with integers from 1 to 3 adapted to fit around the outside of a glass and provided with a count marking clip selectively positionable over each of the integers; and
a data-containing assembly having information regarding a daily caloric intake required to maintain a user's weight and further having information regarding a desired distribution of a quantity of calories to be consumed among various food groups.

10. A method of regulating caloric intake comprising, in combination:
consulting a data-containing assembly having information regarding a daily caloric intake required to maintain a user's weight;
determining a desired caloric intake required to meet a user's weight goal;
consulting a data-containing assembly having information regarding a desired distribution of foods to be consumed among various food groups;
determining a desired quantity of calories to be allocated for each food group;
selecting foods from the food groups desired portions that provide the desired allotment of the desired caloric intake over the various food groups;
filling one or more labeled bowls and plate to provide the desired amount of food from the selected food groups for consumption.
